(19) United States
(12) Patent Application Publication
(10) Pub. No.: US 2026/0330000 A1
(43) Pub. Date: Oct. 22, 2026

(54) PLUGGABLE MODULE ANTI-THEFT PROTECTION

(71) Applicant: Cisco Technology, Inc., San Jose, CA (US)

(72) Inventors: Randy H. ZHANG, Manassas, VA (US); Emerson Luis DE CAMPOS MOURA, Sao Paulo (BR); Maurizio GAZZOLA, Milan (IT)

(21) Appl. No.: 19/183,600

(22) Filed: Apr. 18, 2025

(51) Int. Cl. G06F 21/44

(52) U.S. Cl. CPC G06F 21/44

(57) ABSTRACT

Automatic verification of a host device with an attached pluggable module based on an identifier related to the pluggable module. The pluggable module boots in a locked mode and automatically transmits the identifier to the host device. The host device uses the identifier to retrieve a key in a key vault on a network to use for unlocking the pluggable module. When the host device receives the key from the key vault, the host transmits the key to the pluggable module. The pluggable module verifies the key with a secured key on the pluggable module. If the keys match, the pluggable module unlocks.

### TECHNICAL FIELD

Embodiments presented in this disclosure generally relate to pluggable modules, more specifically, to pluggable modules that verify an attached host device.

### BACKGROUND

Optical transceiver modules are devices that enable the transmission and reception of data over networks. These modules are commonly used in communication systems such as data centers and enterprise networks to provide long-distance data transfer. These modules may be pluggable modules allowing the modules to be moved from one network to another network.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 a block diagram of an environment with a host device that unlocks a pluggable module, according to one embodiment.

FIG. 2 a flowchart of a method for unlocking a pluggable module, according to one embodiment.

FIG. 3 a flowchart of a method for obtaining a key for a host device to unlock a pluggable module, according to one embodiment.

FIG. 4 a block diagram of an environment with a host device that attempts to unlock a pluggable module, according to one embodiment.

FIG. 5 a flowchart of a method for registering a pluggable module to a key vault, according to one embodiment.

FIG. 6 a block diagram of an environment with multiple pluggable modules, according to one embodiment.

FIG. 7 an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes booting a pluggable module attached to a host device into a locked state. The method further includes providing an identifier of the pluggable module to the host device, wherein the host device sends a request, which includes the identifier, to a key vault for a first key associated with the pluggable module. The method further includes receiving the first key at the pluggable module and upon determining the first key matches a saved key stored in protected memory in the pluggable module, unlocking the pluggable module into an operational state.

### Example Embodiments

This disclosure relates to an automated authorization method for pluggable modules. In one embodiment, when a module attaches to a host device to connect to a network, the module boots in a locked state. The module sends the host device an identifier to use to retrieve a key to unlock the module. The host device can obtain the key from cache on the host device or from a key vault on the network. The host device may put the key in cache on the host device and transmit the key to the module. When the host device transmits the key back to the module, the module determines the key matches its internally stored key and unlocks.

In one embodiment, a buyer of the module adds the key for the module to a key vault. By having the module verify that the host device can access the key for the module, the module automatically verifies that the person operating the module is the proper owner of the module. Putting the key in the cache on the host device can speed up the process of unlocking the module after it reboots, but the cache may be cleared after a period of time set by a user. By clearing the cache, it enhances security of the key for the module by lowering the chance the key is stolen from the host device by a nefarious actor.

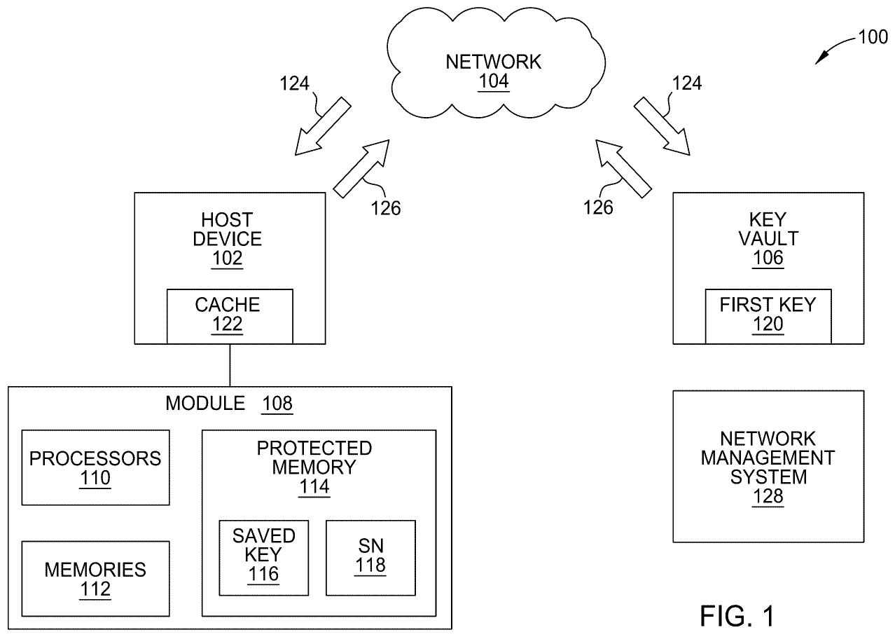

FIG. 1 depicts an environment 100 with a host device that unlocks a pluggable module. Each pluggable module, hereinafter module, has a saved key and an identifier stored in protected memory that can be used for unlocking the module. The protected memory cannot be edited by a customer or a user after the module is manufactured. However, in one embodiment, a manufacturer can edit the protected memory when the module is returned by a customer to ensure the saved key in the module is not known by the previous owner. By the manufacturer changing the saved key in the protected memory of the module, the previous customer or the previous user cannot access the module using an old, saved key. The module can be resold to a different customer with the changed saved key.

In an exemplary embodiment, the saved key and identifier are stored in a secure boot on the module using Secure Unique Device Identifiers (SUDIs). In an embodiment, when the user adds the module to a network, the module first verifies that the host device has a key that matches the saved key on the module. The host device can request the matching key from a key vault on the network. In an exemplary embodiment, the environment 100 includes a host device 102, network 104, key vault 106, module 108, and network management system 128. The module 108 may be, in one embodiment, a pluggable module such as, but not limited to, an optics transceiver, a hardware accelerator, a PCB card, or a pluggable wireless radio. The module 108 includes one or more processors 110, one or more memories 112, and protected memory 114. The protected memory 114 stores saved key 116 and serial number (SN) 118.

When the module 108 attaches to the host device 102, in one embodiment, the module 108 transmits an identifier for the module 108 to the host device 102. In an exemplary embodiment, the module 108 transmits a SN (e.g., one example of a module identifier) to the host device 102. The host device 102 may use the SN to obtain a key that matches a saved key on the module 108 from its cache or from the key vault 106 on the network 104. When the module 108 attaches to the host device 102, the network management system 128 on the network 104 monitors a status for the module 108 and updates a list for status of modules on the network 104. As the network management system 128 monitors the modules on the network 104, the network management system 128 can, in one embodiment, determine when the module 108 is added to the network 104, or the module 108 is disconnected from the network 104, attempts to join the network 104, but the module 108 fails to join. The user of the module 108 can use the status indicated by the network management system 128 to track the status of the module 108 and other modules on the network 104. In an exemplary embodiment, the module 108 attaches to the host device 102 and the module 108 transmits the SN 118 to the host device 102. The network management system 128 adds the module 108 to a list of modules for the network 104 indicating that the module 108 attaches to the host device 102. The host device 102 may check its cache 122 for a key that is associated with the SN 118. If the cache 122 does not have the key associated with the SN 118, the host device 102 requests the key associated with the SN 118 from the key vault 106. The customer or the user can setup a first key 120 in the key vault 106 based on a physical or digital copy of the first key 120 that is associated with the SN 118. The physical or the digital copy of the first key 120 may be given or sold to another user to allow for a proper transfer of the module 108 to the other user. The host device 102 transmits a request 124 to the key vault 106 on the network 104 for the key associated with the SN 118. In an exemplary embodiment, the key vault 106 determines a first key 120 is associated with the SN 118, so the key vault 106 transmits a message 126 to the host device 102 with the first key 120.

In one embodiment, when the host device 102 receives the message 126 from the key vault 106 with the first key 120 associated with the SN 118, the host device 102 may create an association between the first key 120 and the SN 118 and save the association in the cache 122 on the host device. By saving the association in the cache 122, when the module 108, which is associated with the SN 118, boots up attached to the host device 102, the host device 102 can use the first key 120 in the cache 122 for verification instead of requesting the first key 120 from the key vault 106. Regardless of whether the host device 102 obtains a matching key from the cache 122 or from the key vault 106, the host device 102 transmits the matching key to the module 108. If the matching key matches the saved key 116 on the module 108, in one embodiment, then the module 108 unlocks, and the network management system 128 updates the list of modules to reflect the module 108 is unlocked. Otherwise, the module 108 remains locked until the host device 102 transmits the matching key to the module 108. In an exemplary embodiment, the network management system 128 determines that the module 108 failed to unlock after a period of time and updates the list of modules to reflect the module 108 failed to unlock. In an exemplary embodiment, the host device 102 transmits the first key 120 to the module 108. The module 108 determines the first key 120 matches the saved key 116 and unlocks. The network management system 128 updates the list of modules for the network 104 indicating the module 108 is unlocked.

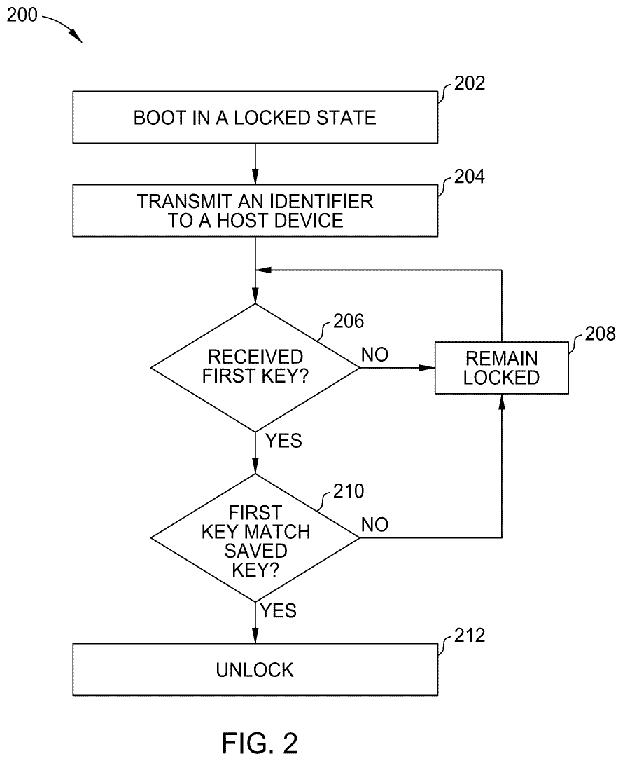

FIG. 2 depicts a method 200 for unlocking a pluggable module that is attached to a host device. At block 202, the module (e.g., the module 108 in FIG. 1) boots in a locked state when attached to host (e.g., the host device 102 in FIG. 1). In one embodiment, when a module is in a locked state, the module is unable to be used beyond verifying a host device until the module is unlocked. In an exemplary embodiment, the module attaches to the host device in a locked state.

At block 204, the module transmits an identifier to the host device. As the module boots while it is attached to the host device, the module automatically transmits the identifier to the host device to start a verification process for the host device. The identifier could be any series of numbers, letters, or symbols that are associated with the module. In an exemplary embodiment, the identifier is a SN (e.g., the SN 118 in FIG. 1) for the module. In an exemplary embodiment, the module transmits the SN to the host device.

At block 206, the module determines if the module received a key from the host device. After the module transmits the identifier to the host device, the module waits, in a locked state, to receive a first key (e.g., the first key 120 in FIG. 1). In one embodiment, the module has not received a key, so the method 200 moves to block 208 keeping the module in the locked state and the method 200 returns to block 206 to wait for the key. Once the key is received, the method 200 moves to block 210.

At block 210, the module determines if the module received a key from the host device that matches a saved key. As described above, the module has a saved key (e.g., the saved key 116 in FIG. 1) in protected memory (e.g., the protected memory 114 in FIG. 1) that is used for verifying a valid host device when booting up. When the module receives the key, the module compares the key to the saved key in protected memory to determine if the keys match. If the keys match, the method 200 moves to block 212. Otherwise, the method 200 moves to block 208 and the module remains in a locked state until the module receives a key (e.g., another key from the host) that matches the saved key.

If the keys match, the method 200 proceeds to block 212 where the module changes to an unlocked state. In one embodiment, when the module is in the unlocked state, the module can operate as intended such as, but not limited to, an optics transceiver module transmitting and receiving optical signals

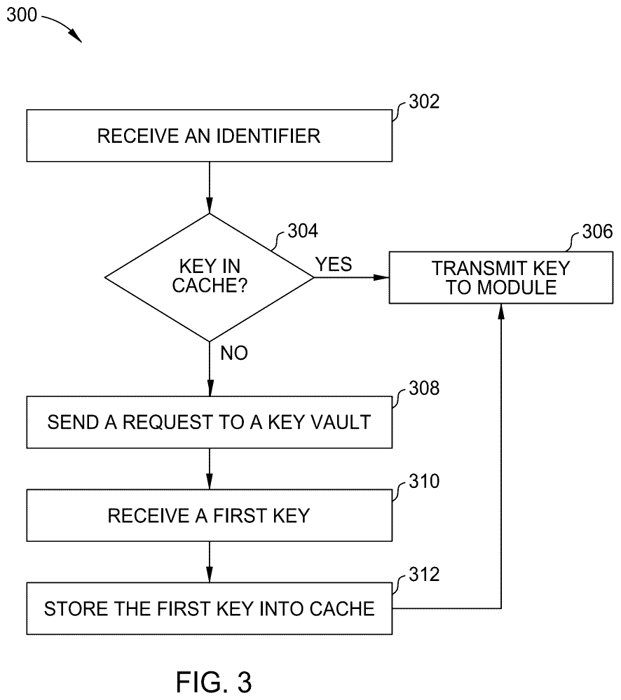

FIG. 3 depicts a method 300 for verifying a host device with a module attached. While FIG. 2 was told from the perspective of the module, method 300 is described from the perspective of the host device (e.g., the host device 102 in FIG. 1). At block 302, the host device receives an identifier from the attached module (e.g., the module 108 in FIG. 1). As described before, the identifier could be any series of numbers, letters, or symbols that are associated with the module. In an exemplary embodiment, the module transmits a SN (e.g., the SSN 118 in FIG. 1) as the identifier to the host device.

At block 304, the host device determines if a cache (e.g., the cache 122 in FIG. 1) on the host device has a key that is associated with the identifier received from the attached module. If so, the method 300 moves to block 306 where the host device transmits the key from the cache on the host device to the module. However, if a key associated with the identifier is not in its cache, the method 300 moves to block 308.

At block 308, the host device sends a request to a key vault (e.g., the key vault 106 in FIG. 1) to look up a key associated with the identifier. The request from host device to the key vault includes the identifier of the module. After the host device transmits the key for the module 108, the host waits for the response from the key vault.

Assuming the key vault stores a key associated with the identifier, at block 310, the host device receives a first key (e.g., the first key 120 in FIG. 1) from the key vault.

At block 312, the host device stores the first key into the cache on the host device. By storing the first key into the cache, the host device can bypass the steps of transmitting a request for a key to the key vault whenever the module reboots on the same host device, and the key exchange process is repeated to again unlock the module. For the host device to retrieve the first key in the cache in the future, the first key is stored with the identifier of the module. The host device can use the identifier received from the module to retrieve the key stored in the cache. However, the host device is not required to store the key in the cache on the host device. Regardless of whether the key is stored in the cache or not, the method 300 moves to block 306 and transmits the key to the module.

The cache may be cleared after an amount of time determined by a user of the host device. By clearing the cache, any keys associated with a module are removed. Clearing the cache enhances security of the keys for the modules associated with the host device by lowering the chance that the keys are stolen by a nefarious actor. When one of the modules associated with the cleared keys boots attaches to the host device, the host device would have to re-retrieve the relative keys from the key vault. In an exemplary embodiment, the cache is configured by a user to clear after 24 hours.

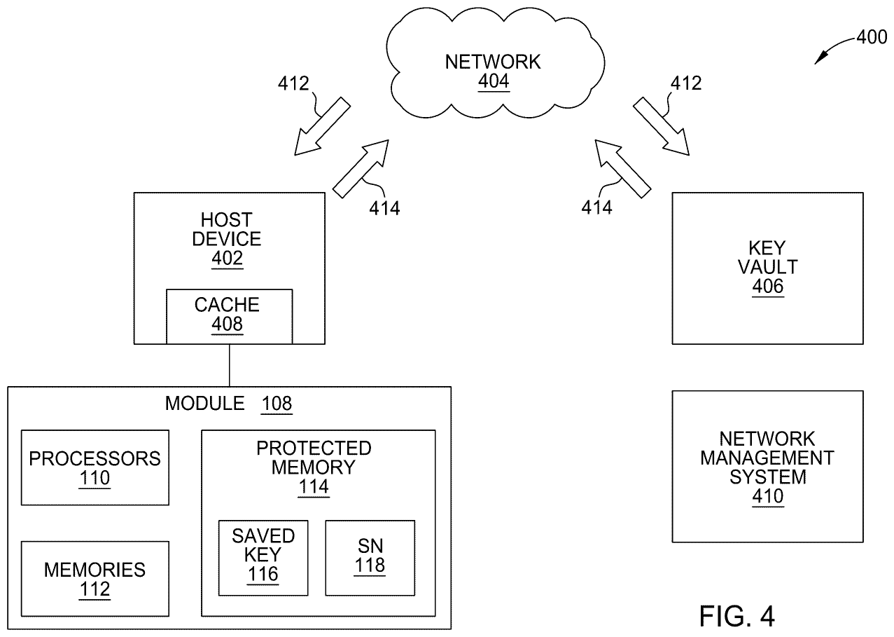

FIG. 4 depicts environment 400 with a host device that attempts to unlock a module. A module may be transferred from one network to another network if a user has a key to set up a key vault to unlock the module. If the user does not have the key to unlock the module, then the module may stay in a locked state. In an exemplary embodiment, the environment 400 includes the module 108, a host device 402, a network 404, a key vault 406, and a network management system 410. Unlike FIG. 1, the key vault 406 was not setup with the first key 120 for unlocking the module 108.

In an exemplary embodiment, the module 108 attaches to the host device 402 and the module 108 transmits the SN 118 to the host device 402. When the module 108 attaches to the host device 402, the network management system 410 adds the module 108 to a list of modules attached to the network 404. The network management system 410 indicates that the module 108 attempts to connect to the network 404. The host device 402 checks the cache 408 for a key associated with the SN 118. Since the cache 408 does not have the key associated with the SN 118, the host device 402 sends a request 412 for the key from the key vault 406. The request 412 includes the SN 118.

The key vault 406 receives the request 412 and checks for the key associated with the SN 118. However, the first key 120 was not set up on the key vault 406, so the key vault 406 sends a message 414 to the host device 402 that the key vault 406 does not have the key. The host device 402 receives the message 414 and halts authentication for the module 108. The module 108 remains locked until the module 108 receives a key that matches the saved key 116. The network management system 410 updates the list of modules for the network 404 to indicate the module 108 was unable to connect to the network 404. Thus, the process disincentives a nefarious actor from stealing the module 108 since it remains in a locked state when taken and used in a network that does not have access to a matching key.

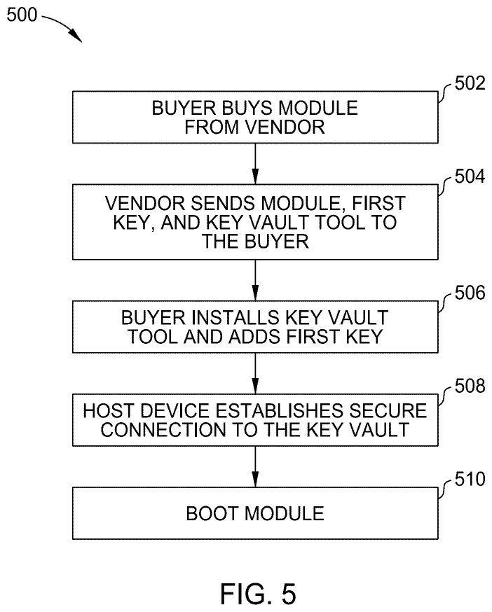

FIG. 5 depicts a method 500 for registering a pluggable module to a key vault. For a key vault to have a key for a module, the module should be registered to the key vault. At block 502, a buyer purchases the module from a vendor. A vendor could be anyone that can transfer ownership of the module to the buyer including a manufacturer of the module or a previous buyer of the module. In an exemplary embodiment, a customer buys the module 108 from a manufacturer of the module 108.

At block 504, the vendor sends the module, a first key, and a key vault tool to the buyer. The first key and key vault tool may be provided to the buyer physically or digitally. For example, the first key may be provided to the buyer as a code on paper or provided as a code on a computer. Examples of providing the key vault tool to the buyer include sending the buyer a link to download a program for the key vault tool or a physical medium that includes the program for the key vault tool. In an exemplary embodiment, the vendor sends the user the module 108, a digital code for the first key 120, and a link to download the key vault 106.

At block 506, the buyer installs the key vault tool and adds the first key to the key vault tool. The buyer puts the program for the key vault tool onto a computing system on a network that the module goes to connect to. By putting the key vault tool onto a computing system, the buyer can add the first key to key vault, so the module can be unlocked when connected to the network.

At block 508, the host device establishes a secure connection on the network to the key vault. For a module to securely connect the network, the host device can have a secure connection with the key vault. This reduces the chance the first key may be intercepted as the host device retrieves the first key from the key vault.

At block 510, the module is attached to the host device and boots up. The module and host device can then go through the processes illustrated in FIGS. 2 and 3 to unlock.

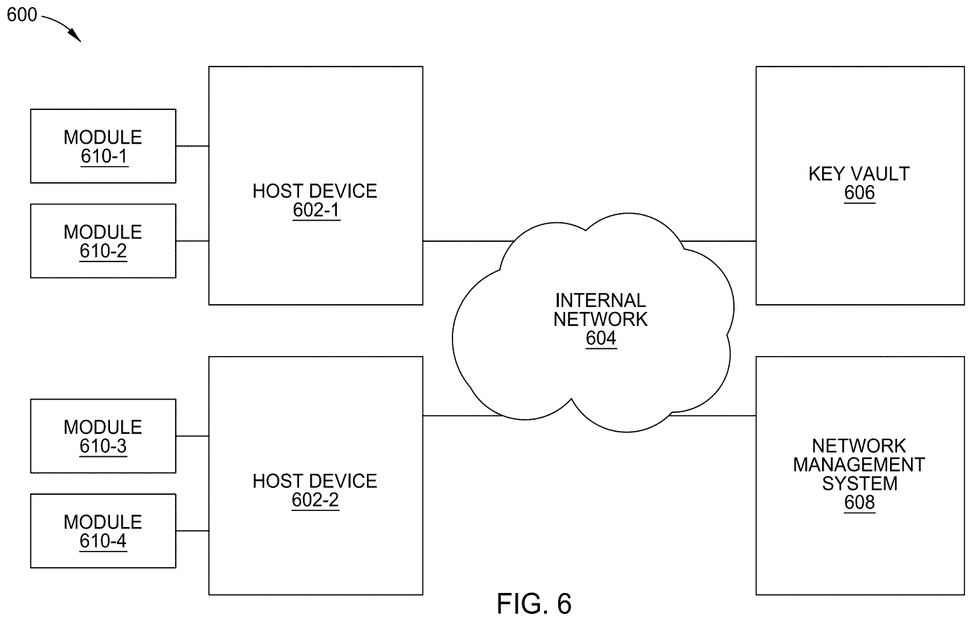

FIG. 6 depicts an environment 600 with multiple modules on a network. A network may include multiple host devices, each including multiple modules. In an exemplary embodiment, the environment 600 includes host device 602-1 and host device 602-2, internal network 604, key vault 606, and network management system 608. Modules 610-1 and 610-2 are attached to the host device 602-1 and modules 610-3 and 610-4 are attached to the host device 602-2. Each of the modules 610-1 through 610-4 have a separate saved key and may have a matching key in the key vault 606. The network management system 608 monitors the modules 610-1 through 610-4 to keep track of any changes in modules on the network 604. For example, the network management system 608 may keep track modules added to the network 604, track when a module fails to connect to the network 604, and when a module is removed from the network 604. The network management system 608 maintains a list of modules that attempt to join the internal network 604. The list of the modules provides the user of the modules a status for each module. In one embodiment, when the user notices a module on the list of the modules that failed to join the internal network, then the user can try to resolve the problem for the module. In an exemplary embodiment, the module 610-1 and 610-2 are attached to the host device 602-1, and the module 610-3 and 610-4 are attached to the host device 602-2.

The host device 602-1 receives matching keys from the key vault 606 for the modules 610-1 and 610-2. The host device 602-2 receives a matching key from the key vault 606 for the module 610-4, but a non-matching key for the module 610-3. The modules 610-1 and 610-2 successfully authenticates the host device 602-1 and the module 610-4 successfully authenticates the host device 602-2, but the module 610-3 is still waiting for a matching key from the host device 602-2. The network management system 608 adds modules 610-1, 610-2, and 610-4 to a list of modules indicating that the modules 610-1, 610-2, and 610-4 are connected to the internal network 604 and adds module 610-3 to the list of modules indicating that the module 610-3 did not receive a matching key. In an exemplary embodiment, the module 610-3 detaches from the host device 602-2. The network management system 608 updates the list of modules to indicate the module 610-3 is not on the network 604.

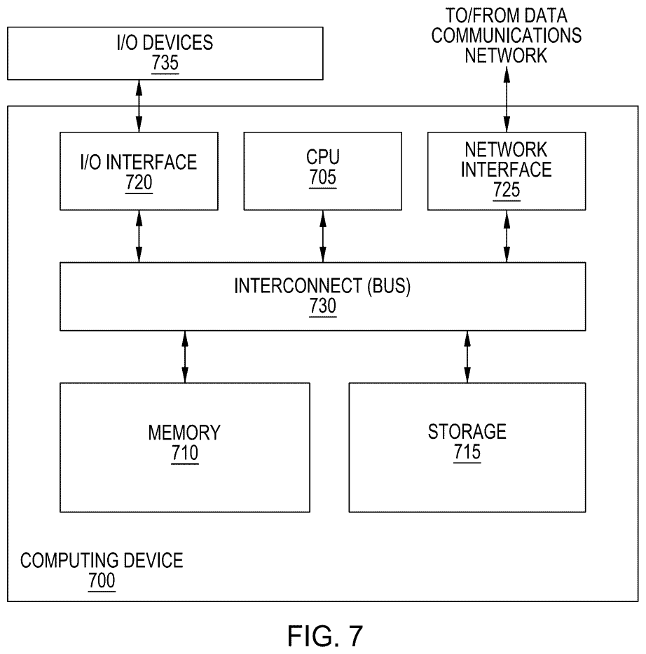

FIG. 7 depicts an example computing device configured to perform various aspects of the present disclosure, according to one embodiment. Although depicted as a physical device, in embodiments, the computing device 700 may be implemented using virtual device(s), and/or across a number of devices (e.g., in a cloud environment). In one embodiment, the computing device 700 corresponds to a network device (e.g., a computing system), such as the host devices 102 and 402.

As illustrated, the computing device 700 includes a CPU 705, memory 710, storage 715, a network interface 725, and one or more input/output (I/O) interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random-access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

The memory 710 can include software programs or applications for obtaining a key to unlock an optics module as discussed above in FIGS. 1-6. Although shown as residing in memory 710, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A pluggable module comprising:
one or more memories; and
one or more processors communicatively coupled to the one or more memories, wherein the one or more processors are configured to, individually or collectively, perform operations comprising:
booting into a locked state when connected to a host device;
transmitting an identifier of the pluggable module to the host device;
receiving a first key from the host device; and
upon determining the first key matches a saved key stored in protected memory in the pluggable module, unlocking into an operational state.

2. The pluggable module of claim 1, wherein the operations comprise:
booting into the locked state when attached to a second host device;
transmitting the identifier of the pluggable module to the second host device;
receiving a second key from the second host device; and
upon determining the second key does not match the saved key stored in the protected memory, remaining in the locked state until the first key is received from the second host device.

3. The pluggable module of claim 1, wherein the identifier is a serial number of the pluggable module.

4. The pluggable module of claim 1, wherein the host device is communicatively coupled with a key vault and a network management system on a same network as the pluggable module.

5. The pluggable module of claim 1, wherein unlocking into the operational state further comprises connecting to a same network as the host device.

6. The pluggable module of claim 1, wherein the saved key and the identifier are stored in a secure boot using Secure Unique Device Identifiers (SUDIs).

7. The pluggable module of claim 6, wherein the saved key and the identifier cannot be edited by a user of the pluggable module.

8. A non-transitory computer-readable medium containing computer program code that, when executed by operation of one or more computer processors, performs operations comprising:
booting a pluggable module into a locked state when connected to a host device;
transmitting an identifier of the pluggable module to the host device;
receiving a first key from the host device; and
upon determining the first key matches a saved key stored in protected memory in the pluggable module, unlocking the pluggable module into an operational state.

9. The non-transitory computer-readable medium of claim 8, wherein the operations comprise:
booting into the locked state when attached to a second host device;
transmitting the identifier of the pluggable module to the second host device;
receiving a second key from the second host device; and
upon determining the second key does not match the saved key stored in the protected memory, remaining in the locked state until the first key is received from the second host device.

10. The non-transitory computer-readable medium of claim 8, wherein the identifier is a serial number of the pluggable module.

11. The non-transitory computer-readable medium of claim 8, wherein the host device is communicatively coupled with a key vault and a network management system on a same network as the pluggable module.

12. The non-transitory computer-readable medium of claim 8, wherein unlocking into the operational state further comprises connecting to a same network as the host device.

13. The non-transitory computer-readable medium of claim 8, wherein the saved key and the identifier are stored in a secure boot using Secure Unique Device Identifiers (SUDIs).

14. The non-transitory computer-readable medium of claim 13, wherein the saved key and the identifier cannot be edited by a user of the pluggable module.

15. A method comprising:
booting a pluggable module attached to a host device into a locked state;
providing an identifier of the pluggable module to the host device, wherein the host device sends a request, which includes the identifier, to a key vault for a first key associated with the pluggable module;
receiving the first key at the pluggable module; and
upon determining the first key matches a saved key stored in protected memory in the pluggable module, unlocking the pluggable module into an operational state.

16. The method of claim 15, further comprises:
booting the pluggable module boots in the locked state when the pluggable module attached to a second host device;
providing the identifier of the pluggable module to the second host device, wherein the second host device sends the request, which includes the identifier, to a second key vault for the first key associated with the pluggable module; and
providing a second key from the second host device to the pluggable module, wherein the second key does not match the saved key in the protected memory and the pluggable module remains in the locked state.

17. The method of claim 15, wherein the identifier is a serial number of the pluggable module and wherein the key vault uses the serial number to identify the first key.

18. The method of claim 15, wherein an owner of the key vault is also the owner of the host device and wherein the key vault and the host device operate on a same network.

19. The method of claim 15, wherein the saved key is stored in a secure boot using Secure Unique Device Identifiers (SUDIs).

20. The method of claim 15, further comprises caching, using the host device, the first key on the host device, and wherein the first key is removed from cache on the host device after an amount of time configured by a user.
